(19) United States
(12) Patent Application Publication
(10) Pub. No.: US 2025/0150178 A1
(43) Pub. Date: May 8, 2025

(54) MEASUREMENT PROCESSING METHOD AND APPARATUS, AND DEVICE

(71) Applicant: VIVO MOBILE COMMUNICATION CO., LTD., Dongguan (CN)

(72) Inventors: Dongru LI, Dongguan (CN); Kai WU, Dongguan (CN)

(73) Assignee: VIVO MOBILE COMMUNICATION CO., LTD., Dongguan (CN)

(21) Appl. No.: 18/977,911

(22) Filed: Dec. 11, 2024

Related U.S. Application Data
(63) Continuation of application No. PCT/CN2023/099106, filed on Jun. 8, 2023.

(30) Foreign Application Priority Data
Jun. 15, 2022 (CN) 202210682247.0

(51) Int. Cl. H04B 17/318; H04B 7/22; H04L 5/00

(52) U.S. Cl. CPC H04B 17/318; H04B 7/22; H04L 5/0048

(57) ABSTRACT

This application provides a measurement processing method and apparatus, and a device. The measurement processing method includes: obtaining, by a first device, measurement configuration information; and performing, by the first device, channel measurement on a backscatter communication channel based on the measurement configuration information. The backscatter communication channel includes at least one of the following: a transmission channel for a backscatter signal; or a transmission channel for a reference signal. The reference signal is used to trigger a first backscatter signal, and the first backscatter signal is used for channel measurement.

### CROSS-REFERENCE TO RELATED APPLICATIONS

This application is a continuation of International Application No. PCT/CN 2023/099106, filed on Jun. 8, 2023, which claims priority to Chinese Patent Application No. 202210682247.0, filed on Jun. 15, 2022. The entire contents of each of the above-referenced applications are expressly incorporated herein by reference.

### TECHNICAL FIELD

This application pertains to the field of communication technologies, and specifically, to a measurement processing method and apparatus, and a device.

### BACKGROUND

Backscatter communication (BSC) means that a backscatter communication device modulates a signal by using a radio frequency signal from another device or environment to transmit information of the backscatter communication device. This can greatly reduce power consumption and costs. The backscatter communication device may be:
a backscatter communication device in conventional radio frequency identification (RFID), where the backscatter communication device is usually a tag and is a passive internet of things (IoT) (passive-IoT) device;
a semi-passive tag, where the tag has a specific amplification capability in downlink reception or uplink reflection; or
a tag with an active sending capability (active tag), where the tag may send information to a reader without depending on reflection of an incident signal.

However, the backscatter communication device does not support channel measurement due to a limited capability of the backscatter communication device. Uncertainty of channel quality leads to poor communication reliability of BSC and other problems.

### SUMMARY

Embodiments of this application provide a measurement processing method and apparatus, and a device.

According to a first aspect, a measurement processing method is provided, including:
obtaining, by a first device, measurement configuration information; and
performing, by the first device, channel measurement on a backscatter communication channel based on the measurement configuration information, where the backscatter communication channel includes at least one of the following:
a transmission channel for a backscatter signal; and
a transmission channel for a reference signal, where the reference signal is used to trigger a first backscatter signal, and the first backscatter signal is used for channel measurement.

According to a second aspect, a measurement processing apparatus is provided, including:
a first processing module, configured to obtain measurement configuration information; and
a second processing module, configured to perform channel measurement on a backscatter communication channel based on the measurement configuration information, where the backscatter communication channel includes at least one of the following:
a transmission channel for a backscatter signal; and
a transmission channel for a reference signal, where the reference signal is used to trigger a first backscatter signal, and the first backscatter signal is used for channel measurement.

According to a third aspect, a measurement processing method is provided. The method includes:
obtaining, by a second device, measurement configuration information, where the measurement configuration information is used for channel measurement on a backscatter communication channel; and
sending, by the second device, a reference signal based on the measurement configuration information, where
the backscatter communication channel includes at least one of the following:
a transmission channel for a backscatter signal; and
a transmission channel for the reference signal, where the reference signal is used to trigger a first backscatter signal, and the first backscatter signal is used for channel measurement.

According to a fourth aspect, a measurement processing apparatus is provided, including:
a third processing module, configured to obtain measurement configuration information, where the measurement configuration information is used for channel measurement on a backscatter communication channel; and
a sending module, configured to send a reference signal based on the measurement configuration information, where
the backscatter communication channel includes at least one of the following:
a transmission channel for a backscatter signal; and
a transmission channel for the reference signal, where the reference signal is used to trigger a first backscatter signal, and the first backscatter signal is used for channel measurement.

According to a fifth aspect, a terminal is provided, where the terminal includes a processor and a memory, the memory stores a program or instructions capable of running on the processor, and when the program or instructions are executed by the processor, the steps of the method according to the first aspect are implemented.

According to a sixth aspect, a communication device is provided, including a processor and a communication interface. The processor is configured to: obtain measurement configuration information; and
perform channel measurement on a backscatter communication channel based on the measurement configuration information, where
the backscatter communication channel includes at least one of the following:
a transmission channel for a backscatter signal; and
a transmission channel for a reference signal, where the reference signal is used to trigger a first backscatter signal, and the first backscatter signal is used for channel measurement.

According to a seventh aspect, a communication device is provided, where the communication device includes a processor and a memory, the memory stores a program or instructions capable of running on the processor, and when the program or instructions are executed by the processor, the steps of the method according to the first aspect are implemented.

According to an eighth aspect, a communication device is provided, including a processor and a communication interface. The processor is configured to obtain measurement configuration information, where the measurement configuration information is used for channel measurement on a backscatter communication channel. The communication interface is configured to send a reference signal based on the measurement configuration information.

The backscatter communication channel includes at least one of the following:
a transmission channel for a backscatter signal; and
a transmission channel for the reference signal, where the reference signal is used to trigger a first backscatter signal, and the first backscatter signal is used for channel measurement.

According to a ninth aspect, a measurement processing system is provided, including a first device and/or a second device. The first device may be configured to perform the steps of the measurement processing method according to the first aspect. The second device may be configured to perform the steps of the measurement processing method according to the third aspect.

According to a tenth aspect, a readable storage medium is provided. The readable storage medium stores a program or instructions. When the program or instructions are executed by a processor, the steps of the method according to the first aspect are implemented, or the steps of the method according to the third aspect are implemented.

According to an eleventh aspect, a chip is provided. The chip includes a processor and a communication interface. The communication interface is coupled to the processor. The processor is configured to run a program or instructions, to implement the method according to the first aspect, or implement the method according to the third aspect.

According to a twelfth aspect, a computer program or program product is provided. The computer program or program product is stored in a storage medium. The computer program or program product is executed by at least one processor to implement the steps of the method according to the first aspect, or implement the steps of the method according to the third aspect.

In the embodiments of this application, for a backscatter communication channel, the first device obtains measurement configuration information and can perform channel measurement on the backscatter communication channel based on the measurement configuration information to determine channel quality of the backscatter communication channel. This avoids poor communication reliability and other problems caused by uncertainty of channel quality.

### BRIEF DESCRIPTION OF DRAWINGS

FIG. 1 is a block diagram of a wireless communication system;

FIG. 2 is a first schematic flowchart of a method according to an embodiment of this application;

FIG. 3 is a first schematic diagram of application of a method according to an embodiment of this application;

FIG. 4 is a second schematic diagram of application of a method according to an embodiment of this application;

FIG. 5 is a third schematic diagram of application of a method according to an embodiment of this application;

FIG. 6 is a fourth schematic diagram of application of a method according to an embodiment of this application;

FIG. 7 is a second schematic flowchart of a method according to an embodiment of this application;

FIG. 8 is a schematic modular diagram of an apparatus corresponding to FIG. 2;

FIG. 9 is a schematic modular diagram of an apparatus corresponding to FIG. 7;

FIG. 10 is a schematic structural diagram of a communication device according to an embodiment of this application;

FIG. 11 is a schematic structural diagram of a terminal according to an embodiment of this application; and

FIG. 12 is a schematic structural diagram of a network-side device according to an embodiment of this application.

### DETAILED DESCRIPTION

The following clearly describes the technical solutions in the embodiments of this application with reference to the accompanying drawings in the embodiments of this application. Clearly, the described embodiments are some but not all of the embodiments of this application. All other embodiments obtained by persons of ordinary skill in the art based on the embodiments of this application fall within the protection scope of this application.

The terms “first”, “second”, and the like in this specification and the claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not limit the number of objects. For example, there may be one or more first objects. In addition, in this specification and the claims, “and/or” indicates at least one of connected objects, and the character “/” generally indicates an “or” relationship between contextually associated objects.

It should be noted that technologies described in the embodiments of this application are not limited to a long term evolution (LTE)/LTE-advanced (LTE-A) system, and may also be applied to other wireless communication systems, such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, and the technology described herein may be used in the aforementioned systems and radio technologies as well as other systems and radio technologies. In the following descriptions, a new radio (NR) system is described for an illustration purpose, and NR terms are used in most of the following descriptions, but these technologies may also be applied to applications other than an NR system application, for example, a 6th generation (6G) communication system.

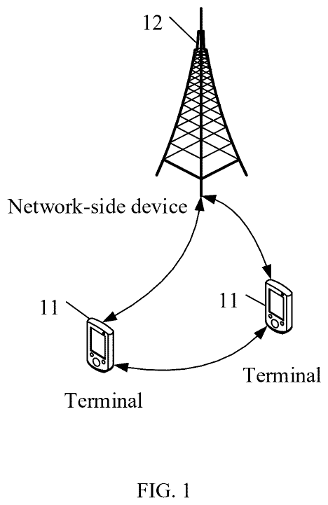

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (a home appliance with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the art. Provided that the same technical effect is achieved, the base station is not limited to a specific technical term. It should be noted that the base station in the NR system is used only as an example for description in the embodiments of this application, but a specific type of the base station is not limited.

In the embodiments, an example in which a backscatter communication device is a tag device is used for description.

In the embodiments, backscatter communication includes transmission of the following content:
(1) A carrier wave (CW): In an embodiment, the carrier wave may be sent by a network-side device or a terminal to a tag.
(2) A control command, for example, a select command, a query command, a repetition query command, a reply command, a read command, a write command, or a random request command: In an embodiment, the control command may be sent by a network-side device or a terminal to a tag.

In some embodiments, the control command may include at least one of the following: a select-type command, a query-type command, and an access command. The select-type command includes at least one of the following: a select command (a specific select command), an inventory command, and a sort command. The query-type command includes at least one of the following: a query command (a specific query command), an adjustment query command, and a repetition query command. The access command includes at least one of the following: a random request command, a read command, a write command, a destroy command, a lock command, an access command, a security-related access command, and a file management-related access command.

The select-type command is required. Because a tag has a plurality of attributes, changing some attributes and marks based on a user-specified standard and strategy by using the select-type command means manually selecting or identifying a specific tag group, so that an inventory, recognition, or access operation can be performed only on these attributes and marks. This helps reduce conflicts and repetitive recognition and increase a recognition speed.

A command in an inventory stage is used to start a round of inventory. For example, the query command is used to start a round of inventory and determine marks that are to participate in this round of inventory, the adjustment query command is used to adjust the number of original receiving slots of the tag, and the repetition query command is used to reduce the number of slots of the tag.

In the access command, the random request (Req_RN) command requires the tag to generate a random number, the read command is used to read data from a specific location in storage of the tag, the write command is used to write data to the storage of the tag, the destroy command can prevent leakage of privacy, where the tag can no longer be used, the lock command is used when the tag can no longer perform a write action, to prevent data from being altered arbitrarily, the access command is used to switch the tag from an open state to a secure state when the tag has a password, the security-related access command is used to ensure security of the tag, and the file management-related access command may be used to manage files within the tag.
(3) Backscatter information, such as tag identification information (for example, a 16-bit random number (RN16) temporarily representing an identity of a tag during a query process), electronic product code (EPC) or Product Code (PC) information, and tag status information. This is not limited herein. In an embodiment, the backscatter channel or signal may be sent by a tag to a terminal or a network-side device through backscattering.

The following describes in detail a measurement processing method and apparatus, and a device provided in the embodiments of this application with reference to the accompanying drawings and by using some embodiments and application scenarios thereof.

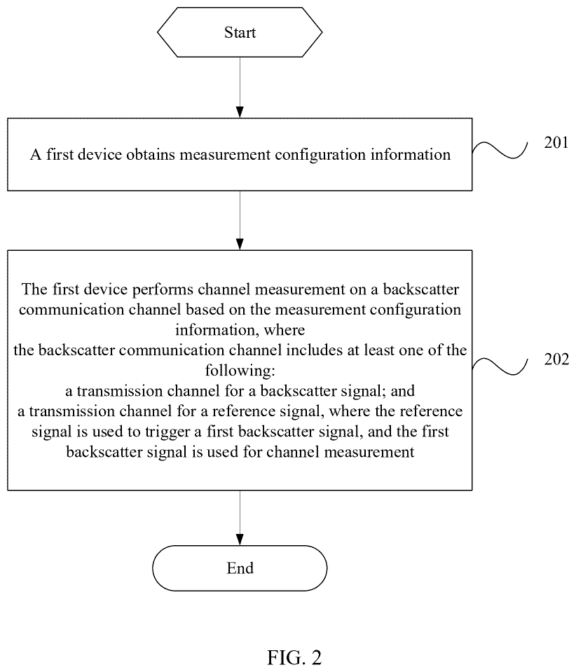

As shown in FIG. 2, a measurement processing method according to an embodiment of this application includes the following steps.

Step 201: A first device obtains measurement configuration information.

Herein, the measurement configuration information is used for channel measurement on a backscatter communication channel. The measurement configuration information may be predefined, or may be configured by a network-side device. Therefore, that the first device performs step 201 includes: extracting stored predefined measurement configuration information, receiving measurement configuration information sent by the network-side device, or the like.

In this embodiment, the first device may be a terminal, a network-side device, or the like. This is not limited herein.

Step 202: The first device performs channel measurement on a backscatter communication channel based on the measurement configuration information.

The backscatter communication channel includes at least one of the following:
a transmission channel for a backscatter signal; and
a transmission channel for a reference signal, where the reference signal is used to trigger a first backscatter signal, and the first backscatter signal is used for channel measurement.

In this step, the first device performs channel measurement on the transmission channel for the backscatter signal and/or the transmission channel for the reference signal based on the measurement configuration information obtained in step 201. It should be noted that the backscatter signal carries the foregoing backscatter information. In an embodiment, the first device performs channel measurement on the transmission channel for the backscatter signal based on the measurement configuration information. The transmission channel for the backscatter signal may be a communication channel between a network-side device and a tag, or a communication channel between a terminal-side device and a tag.

It can be understood that the reference signal is also indirectly used for the channel measurement. A direct function of the reference signal is to trigger the first backscatter signal. Finally, the first device performs channel measurement based on the received first backscatter signal.

In this embodiment, for the backscatter communication channel, the first device obtains the measurement configuration information and can perform channel measurement on the backscatter communication channel based on the measurement configuration information to determine channel quality of the backscatter communication channel. This avoids poor communication reliability and other problems caused by uncertainty of channel quality.

It should be noted that the first device can implement channel measurement on the transmission channel for the backscatter signal by receiving the first backscatter signal on the transmission channel for the backscatter signal. For channel measurement on the transmission channel for the reference signal, because the reference signal is used to trigger the first backscatter signal, indirect estimation may be performed based on alignment with a measurement result for the transmission channel for the backscatter signal.

In this embodiment, for the first backscatter signal, a status change of an object (where a tag is attached to the object), for example, a change of temperature, humidity, or a PH value and whether food has deteriorated, may be determined by measuring strength of the backscatter signal. This is because strength of a backscatter signal emitted by the tag can reflect the status change to some extent. In addition, in another embodiment, ranging (positioning) may be performed by measuring a backscatter signal. A network-side device may determine, based on a measurement metric such as received power of a first backscatter signal, whether a tag is within a coverage area or a distance from a querier or a reader (reader), to be specific, calculate a relative distance based on a path loss, or determine an approximate location of the tag.

In some embodiments, the backscatter communication channel can transmit at least one of the following: a carrier wave (CW), a control command, and backscatter information.

In this embodiment, the measurement configuration information includes at least one of the following:
a measurement metric;
a measurement resource;
a periodicity type;
a periodicity length;
configuration information related to the reference signal; and
configuration information related to the first backscatter signal.

The periodicity type is a periodicity type of a measurement resource corresponding to transmission of the reference signal. The periodicity length is also a periodicity length of the measurement resource. For example, the periodicity length is 10 ms, 20 ms, or 40 ms.

In this embodiment, the periodicity type includes at least one of the following:
periodic;
semi-persistent; and
aperiodic.

To be specific, the measurement may be periodic, semi-persistent, or aperiodic measurement.

In this embodiment, the reference signal includes at least one of the following:
a carrier wave;
a control command; and
a preamble.

Herein, if the reference signal is a carrier wave, the carrier wave is a carrier wave for triggering the first backscatter signal; if the reference signal is a control command, the control command is a control command for triggering the first backscatter signal; or if the reference signal is a preamble, the preamble is a preamble for triggering the first backscatter signal.

In this embodiment, the configuration information related to the reference signal includes at least one of the following:
time domain resource information;
frequency domain resource information;
transmitting power information;
a modulation scheme;
a coding scheme;
a mapping mode;
resource density; and
a signaling format.

In some embodiments, the time domain resource information is time domain resource information, for example, a time domain location or a time domain length (size), of a measurement resource, and the frequency domain resource information is frequency domain resource information of the measurement resource.

In an embodiment, the frequency domain resource information includes at least one of the following: a frequency domain location (including at least one of a frequency band, a center frequency, a serving cell, and a bandwidth part (BWP)) and a frequency domain length (size).

In some embodiments, at least one of the transmitting power information (for example, a transmitting power size), the modulation scheme, the coding scheme, the mapping mode, the resource density, and the signaling format (for example, a long or short signaling format) may be pre-agreed-upon, or may be configured by the network-side device.

In some embodiments, the configuration information related to the first backscatter signal includes at least one of the following:
a backscatter signal type;
time domain resource information;
frequency domain resource information;
a modulation scheme;
a coding scheme;
a carrier frequency; and
a reflection coefficient.

In some embodiments, the configuration information related to the first backscatter signal may be preconfigured or agreed upon in a protocol, or may be determined based on an association relationship with the reference signal.

In some embodiments, the backscatter signal type is a type of the first backscatter signal, and may be a specific sequence (for example, 1010101010 or 111111111) or specific information (for example, an RN16, an EPC, or a backscatter signal gain or loss indication). The modulation scheme may be double sideband (DSB) amplitude shift keying (ASK) (DSB-ASK), single sideband (SSB) ASK (SSB-ASK), or phase reversal (PR) ASK (PR-ASK). The coding scheme may be Manchester coding, Miller coding, or FM0 coding. In addition, the carrier frequency and/or the reflection coefficient are preconfigured or agreed upon in a protocol for a reader and a tag.

In some embodiments, the time domain resource information is time domain resource information, for example, a time domain location or a time domain length (size), of a backscatter signal, and the frequency domain resource information is frequency domain resource information of the backscatter signal.

In an embodiment, the frequency domain resource information includes at least one of the following: a frequency domain location (including at least one of a frequency band, a center frequency, a serving cell, and a bandwidth part (BWP)) and a frequency domain length (size).

In some embodiments, the measurement metric includes at least one of the following:
received power of a first backscatter signal;
received quality of a first backscatter signal;
a received signal strength indicator (RSSI);
a signal to interference plus noise ratio (SINR);
cross-link interference (CLI); and
a channel quality indicator (CQI).

Herein, each measurement metric may also be referred to as a measurement quantity or a measurement item.

In some embodiments, the received power of a first backscatter signal is the received power of the first backscatter signal that is within first bandwidth and that is centered on a first frequency, where, for example, the first frequency is a carrier frequency;
the RSSI is the received power of a signal that is within second bandwidth and that is centered on a second frequency, where, for example, the second frequency is a carrier frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, and a preset precoding matrix indicator.

It should be noted that the RSSI is power of signals received within entire bandwidth of the second bandwidth by using the second frequency as a center.

In some embodiments, the first frequency and the second frequency may be a backscatter frequency of a tag that is pre-agreed-upon or configured by the network-side device, and the first frequency and the second frequency may be the same or different.

In some embodiments, the first bandwidth and the second bandwidth may also be pre-agreed-upon or configured by the network-side device, and the first bandwidth and the second bandwidth may be the same or different.

In some embodiments, the obtained signal power may be total power or average power of signals.

In some embodiments, the useful signal may be the first backscatter signal, and received power of the useful signal is the received power of the first backscatter signal. The interference power is obtained through interference measurement that is predefined or configured by the network-side device.

In some embodiments, the CLI may be determined by measuring a carrier wave or a control command signal, and is applicable to a scenario with a relay. Interference in the SINR may include the CLI.

In some embodiments, the preset antenna, the preset rank indicator RI, and the preset precoding matrix indicator PMI based on which the CQI is obtained may be predefined, or may be indicated by the network-side device. In a process of obtaining the CQI, for example, a calculated RI, instead of the preset RI, may be used; and a calculated PMI, instead of the preset PMI, may be used.

Further, that the received quality of the first backscatter signal is obtained based on the received power of the first backscatter signal and the RSSI may mean that the received quality of the first backscatter signal is obtained by dividing the received power of the first backscatter signal by the RSSI.

Further, that the SINR is obtained based on received power, interference power, and noise power of a useful signal may mean that the SINR is calculated based on the received power of the first backscatter signal, the interference power, and the noise power. For example, SINR=S/(I+N), where S represents the received power of the first backscatter signal, I represents the interference power, and N represents the noise power. In some embodiments, interference in the SINR may include the CLI.

In addition, in this embodiment, before step 202, the method further includes the following step:

The first device sends the reference signal based on the measurement configuration information.

To be specific, the first device may send the reference signal based on the measurement configuration information, for example, send the reference signal on a measurement resource indicated by the measurement configuration information. The reference signal triggers the first backscatter signal. To be specific, if a backscatter communication device receives the reference signal, the first backscatter signal is triggered, and the first device performs channel estimation by receiving the first backscatter signal. In some embodiments, the first device may simultaneously send the reference signal and receive the first backscatter signal.

For example, the first backscatter signal received by the first device may be triggered by a reference signal sent by a second device (a communication device different from the first device). The second device may obtain the measurement configuration information and send the reference signal based on the measurement configuration information.

In this embodiment, that the first device performs channel measurement on a backscatter communication channel based on the measurement configuration information includes:

The first device performs channel measurement based on the measurement configuration information by receiving the first backscatter signal.

Herein, the first backscatter signal may be triggered by a reference signal sent by the first device or by a reference signal sent by the second device. Details are not described herein again.

In this embodiment, the first device may be a network-side device or a terminal.

In some embodiments, after the first device performs channel measurement based on the measurement configuration information by receiving the first backscatter signal, the method further includes the following step:

The first device transmits, on a corresponding reporting resource based on reporting configuration information, a measurement result obtained by the channel measurement, where the reporting configuration information is preconfigured information.

In this case, the first device is a terminal. To be specific, for channel measurement performed by a terminal, a network-side device can learn of, through reporting by the terminal, a measurement result obtained by the channel measurement. The terminal may further report backscatter information to the network-side device. A reporting resource used for reporting the backscatter information may be the same as or different from a reporting resource used for reporting the measurement result.

In some embodiments, the measurement result is a result of the foregoing measurement metric or measurement item.

In addition, in this embodiment, after step 202, the method further includes the following steps:

The first device obtains transmission strategy adjustment information, where the transmission strategy adjustment information is determined based on the measurement result obtained by the channel measurement; and
the first device performs at least one of the following:
adjusting a transmission parameter of backscatter communication based on the transmission strategy adjustment information; and
sending the transmission strategy adjustment information to a second device.

Herein, the transmission strategy adjustment information represents an expectation for a transmission parameter of backscatter communication, namely, an adjustment objective. The transmission parameter of backscatter communication is adjusted based on the transmission strategy adjustment information to achieve better backscatter communication.

If the first device is a network-side device, the network-side device obtains a measurement result in step 202, and then determines transmission strategy adjustment information based on the measurement result. The network-side device may adjust a transmission parameter of backscatter communication based on the transmission strategy adjustment information; or may send the transmission strategy adjustment information to a second device (for example, a terminal), so that the terminal adjusts a transmission parameter of backscatter communication based on the transmission strategy adjustment information. The network-side device may directly adjust the transmission parameter of backscatter communication based on the measurement result.

If the first device is a terminal, the terminal obtains a measurement result in step 202 and then reports the measurement result to a network-side device. The network-side device determines transmission strategy adjustment information based on the reported measurement result, and indicates the transmission strategy adjustment information to the terminal. After receiving the transmission strategy adjustment information, the terminal may directly adjust a transmission parameter of backscatter communication based on the transmission strategy adjustment information.

Herein, the transmission parameter includes at least one of the following: time domain resource information, frequency domain resource information (for example, a transmission frequency band or a center frequency), transmitting power information, and a modulation scheme (for example, DSB-ASK, SSB-ASK, or PR-ASK). For example, the transmission parameter may include other items. Details are not described herein. A transmission parameter adjustment indication may be understood as a transmission parameter update indication.

In this embodiment, the reporting configuration information includes at least one of the following:
a periodicity type;
a periodicity length; and
a reporting resource.

Herein, the periodicity type is a periodicity type of the reporting resource, and may be a periodic, semi-persistent, or aperiodic type. To be specific, the reporting may be periodic, semi-persistent, or aperiodic reporting. The periodicity length is also a periodicity length of the reporting resource. For example, the periodicity length is 10 ms, 20 ms, or 40 ms. Reporting resource information includes time domain resource information and/or frequency domain resource information of the reporting resource. In some embodiments, the time domain resource information includes at least one of the following: a time domain location and a time domain length (size); and the frequency domain resource information includes at least one of the following: (including at least one of a frequency band, a center frequency, a serving cell, and a BWP) and a frequency domain length (size).

In this embodiment, a frequency at which the first device performs the channel measurement is greater than or equal to a frequency at which a measurement result is reported based on the channel measurement.

For example, refer to Table 1.

TABLE 1

| | Periodic | Semi-persistent | Aperiodic |
|---|---|---|---|
| | reporting | reporting | reporting |
| Periodic measurement | Supported | Supported | Supported |
| Semi-persistent | Not supported | Supported | Supported |
| measurement | | | |
| Aperiodic measurement | Not supported | Not supported | Supported |

For example, the first device is a terminal. If the terminal supports periodic measurement, the terminal can support periodic reporting, semi-persistent reporting, and aperiodic reporting. If the terminal supports semi-persistent measurement, the terminal supports semi-persistent reporting and aperiodic reporting, and does not support periodic reporting. If the terminal supports aperiodic measurement, the terminal supports aperiodic reporting, and does not support periodic reporting or semi-persistent reporting.

The following describes specific application of the method in the embodiments of this application with reference to specific scenarios.

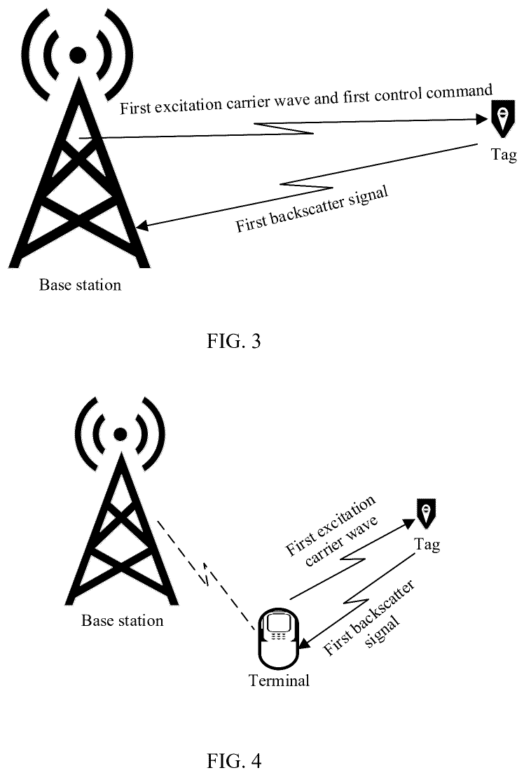

Scenario 1: In a scenario for cellular backscatter without user equipment (UE) assisted (Scenarios for cellular backscatter-w/o UE assisted) shown in FIG. 3, backscatter communication is performed between a base station and a backscatter communication device. Herein, a first device is the base station.

Preconfigured measurement configuration information includes a measurement resource. A periodicity type of the measurement resource is periodic. A reference signal is a first carrier wave and a first control command that are used to trigger a first backscatter signal. Configuration information related to the reference signal, for example, a transmitting power size, a center frequency, a frequency band, a modulation scheme, a coding scheme, or a signaling format, is preconfigured by a network side. A measurement metric is received power of a first backscatter signal.

Therefore, the base station may extract stored preconfigured measurement configuration information, and send a reference signal, namely, the first carrier wave and the first control command, based on the measurement configuration information. Based on the first control command in the received reference signal, a tag learns that the first control command triggers the tag to send the first backscatter signal (this may also be understood as triggering the tag to perform backscattering for channel measurement). Therefore, the tag performs backscattering by receiving the first carrier wave in the reference signal. In this case, the first backscatter signal is sent through backscattering. A reflection coefficient of backscattering by the tag is preconfigured. The base station receives the first backscatter signal and performs channel measurement based on the first backscatter signal.

During channel measurement, for the measurement metric received power of the first backscatter signal, the base station obtains received power of a first backscatter signal within backscatter bandwidth by using a backscatter frequency of the tag as a center frequency. The backscatter bandwidth of the tag is configured by the network side.

Therefore, the base station further autonomously adjusts a corresponding transmission parameter of a terminal or the tag based on a measurement result obtained by the channel measurement, to improve transmission reliability. For example, the base station may determine transmission strategy adjustment information based on the measurement result, and send the transmission strategy adjustment information to the terminal, to indicate the terminal and/or the tag to adjust a transmission parameter of backscatter communication.

Scenario 2: In a scenario for cellular backscatter shown in FIG. 4, a terminal sends a carrier wave and a control command to a tag. In addition, the terminal receives a reflected signal from the tag. Herein, a first device is the terminal.

Preconfigured measurement configuration information includes a measurement resource. A periodicity type of the measurement resource is aperiodic. A reference signal is a first carrier wave for triggering a first backscatter signal. Configuration information related to the reference signal, for example, a transmitting power size, a center frequency, a frequency band, a modulation scheme, a coding scheme, or a signaling format, is preconfigured by a network side. A measurement metric is received power of a first backscatter signal.

Therefore, the terminal may extract stored preconfigured measurement configuration information, and send a reference signal, namely, the first carrier wave, based on the measurement configuration information. The tag performs backscattering based on the received reference signal (the first carrier wave). In this case, the first backscatter signal is sent through backscattering. A reflection coefficient of backscattering by the tag is preconfigured. The terminal receives the first backscatter signal and performs channel measurement based on the first backscatter signal.

During channel measurement, for the measurement metric received power of the first backscatter signal, the terminal obtains the received power of the first backscatter signal within backscatter bandwidth by using a backscatter frequency of the tag as a center frequency. The backscatter bandwidth of the tag is configured by the network side.

The terminal may further report a measurement results obtained by the channel measurement to a base station. The terminal performs reporting on a corresponding reporting resource based on preconfigured reporting configuration information. Herein, content of the reporting configuration information is similar to content of the measurement configuration information. Details are not described herein again. In addition, it should be noted that a periodicity type of the reporting resource needs to ensure that a reporting cycle is shorter than or equal to a measurement cycle. To be specific, if the measurement is aperiodic, the reporting is also aperiodic.

Therefore, the base station further autonomously adjusts a corresponding transmission parameter of the terminal or the tag based on the reported measurement result. For example, the base station may determine transmission strategy adjustment information based on the reported measurement result, and send the transmission strategy adjustment information to the terminal, to indicate the terminal and/or the tag to adjust a transmission parameter of backscatter communication.

In some embodiments, after receiving the first backscatter signal, the terminal sends collected information (for example, the measurement result) to a network device through a uu port.

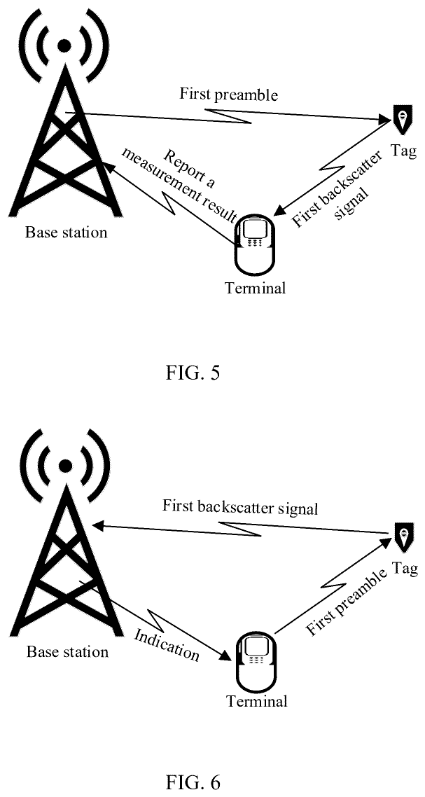

Scenario 3: In a scenario for cellular backscatter with UE assisted (Scenarios for cellular backscatter with UE assisted) shown in FIG. 5, a terminal receives a reflected signal from a tag. Herein, a first device is the terminal.

Preconfigured measurement configuration information includes a measurement resource. A periodicity type of the measurement resource is periodic. A reference signal is a first preamble for triggering a first backscatter signal. Configuration information related to the reference signal, for example, a transmitting power size, a center frequency, a frequency band, a modulation scheme, a coding scheme, or a signaling format, is preconfigured by a network side. A measurement metric is received power of a first backscatter signal.

Therefore, both the terminal and a base station may extract stored preconfigured measurement configuration information. In this case, the base station sends a reference signal, namely, the first preamble, based on the measurement configuration information. The tag performs backscattering based on the received reference signal (the first preamble). In this case, the first backscatter signal is sent through backscattering. A reflection coefficient of backscattering by the tag is preconfigured. The terminal receives the first backscatter signal and performs channel measurement based on the first backscatter signal.

During channel measurement, for the measurement metric received power of the first backscatter signal, the terminal obtains received power of a first backscatter signal within backscatter bandwidth by using a backscatter frequency of the tag as a center frequency. The backscatter bandwidth of the tag is configured by the network side.

The terminal may further report a measurement results obtained by the channel measurement to a base station. The terminal performs reporting on a corresponding reporting resource based on preconfigured reporting configuration information. Herein, content of the reporting configuration information is similar to content of the measurement configuration information. Details are not described herein again. In addition, it should be noted that a periodicity type of the reporting resource needs to ensure that a reporting cycle is shorter than or equal to a measurement cycle. To be specific, if the measurement is aperiodic, the reporting is also aperiodic.

Therefore, the base station further autonomously adjusts a corresponding transmission parameter of the terminal or the tag based on the reported measurement result. For example, the base station may determine transmission strategy adjustment information based on the reported measurement result, and send the transmission strategy adjustment information to the terminal, to indicate the terminal and/or the tag to adjust a transmission parameter of backscatter communication.

Scenario 4: In a scenario for cellular backscatter with UE assisted (Scenarios for cellular backscatter with UE assisted) shown in FIG. 6, a base station receives a reflected signal from a tag. Herein, a first device is the base station.

Preconfigured measurement configuration information includes a measurement resource. A periodicity type of the measurement resource is periodic. A reference signal is a first preamble for triggering a first backscatter signal. Configuration information related to the reference signal, for example, a transmitting power size, a center frequency, a frequency band, a modulation scheme, a coding scheme, or a signaling format, is preconfigured by a network side. A measurement metric is received power of a first backscatter signal.

Therefore, both a terminal and the base station may extract stored preconfigured measurement configuration information. The terminal sends a reference signal, namely, the first preamble, based on the measurement configuration information. The tag performs backscattering based on the received reference signal (the first preamble). In this case, the first backscatter signal is sent through backscattering. A reflection coefficient of backscattering by the tag is preconfigured. The base station receives the first backscatter signal and performs channel measurement based on the first backscatter signal.

During channel measurement, for the measurement metric received power of the first backscatter signal, the base station obtains the received power of the first backscatter signal within backscatter bandwidth by using a backscatter frequency of the tag as a center frequency. The backscatter bandwidth of the tag is configured by the network side.

Therefore, the base station further autonomously adjusts a corresponding transmission parameter of a terminal or the tag based on a measurement result obtained by the channel measurement, to improve transmission reliability. For example, the base station may determine transmission strategy adjustment information based on the measurement result obtained by the channel measurement, and send the transmission strategy adjustment information to the terminal, to indicate the terminal and/or the tag to adjust a transmission parameter of backscatter communication.

To sum up, for a backscatter communication channel, the first device obtains measurement configuration information and can perform channel measurement on the backscatter communication channel based on the measurement configuration information to determine channel quality of the backscatter communication channel. This avoids poor communication reliability and other problems caused by uncertainty of channel quality.

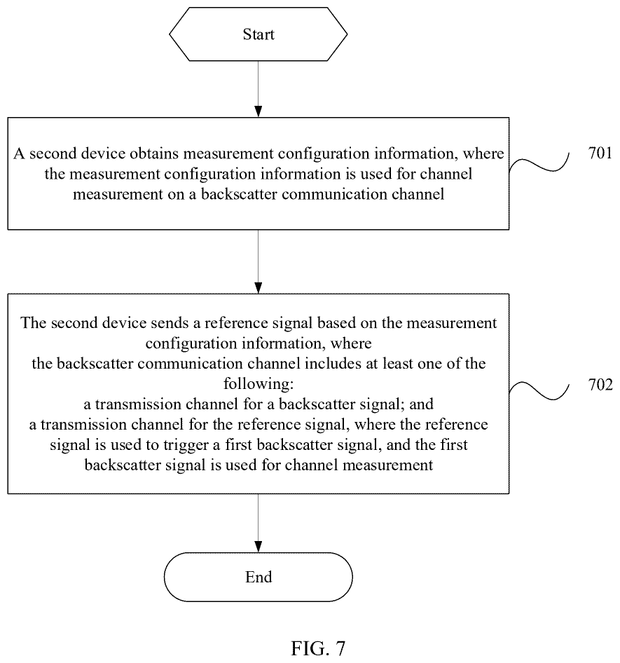

As shown in FIG. 7, a measurement processing method according to an embodiment of this application includes the following steps.

Step 701: A second device obtains measurement configuration information, where the measurement configuration information is used for channel measurement on a backscatter communication channel.

Herein, the measurement configuration information may be predefined, or may be configured by a network-side device. Therefore, that the second device performs step 701 includes: extracting stored predefined measurement configuration information, receiving measurement configuration information sent by the network-side device, or the like.

In this embodiment, a first device may be a terminal, a network-side device, or the like. This is not limited herein.

Step 702: The second device sends a reference signal based on the measurement configuration information.

The backscatter communication channel includes at least one of the following:
a transmission channel for a backscatter signal; and
a transmission channel for the reference signal, where the reference signal is used to trigger a first backscatter signal, and the first backscatter signal is used for channel measurement.

In this step, the second device sends the reference signal based on the measurement configuration information obtained in step 701 to trigger the first backscatter signal, so that the first device performs channel measurement on the backscatter communication channel. It should be noted that the backscatter signal carries the foregoing backscatter information. In an embodiment, the first device performs channel measurement on the transmission channel for the backscatter signal based on the measurement configuration information. The transmission channel for the backscatter signal may be a communication channel between a network-side device and a tag, or a communication channel between a terminal-side device and a tag.

It can be understood that the reference signal is also indirectly used for the channel measurement. A direct function of the reference signal is to trigger the first backscatter signal. Finally, the first device performs channel measurement based on the received first backscatter signal.

In this embodiment, the second device obtains the measurement configuration information and can send the reference signal based on the measurement configuration information to trigger the first backscatter signal. In this way, after obtaining the measurement configuration information, the first device performs channel measurement on the backscatter communication channel based on the measurement configuration information by using the first backscatter signal, to determine channel quality of the backscatter communication channel. This avoids poor communication reliability and other problems caused by uncertainty of channel quality.

In some embodiments, the backscatter communication channel can transmit at least one of the following: a CW, a control command, and backscatter information.

The periodicity type is a periodicity type of a measurement resource corresponding to transmission of the reference signal. The periodicity length is also a periodicity length of the measurement resource. For example, the periodicity length is 10 ms, 20 ms, or 40 ms.

In this embodiment, the periodicity type includes at least one of the following: periodic;
semi-persistent; and
aperiodic.

To be specific, the measurement may be periodic, semi-persistent, or aperiodic measurement.

In this embodiment, the reference signal includes at least one of the following:
a carrier wave;
a control command; and
a preamble.

Herein, if the reference signal is a carrier wave, the carrier wave is a carrier wave for triggering the first backscatter signal; if the reference signal is a control command, the control command is a control command for triggering the first backscatter signal; or if the reference signal is a preamble, the preamble is a preamble for triggering the first backscatter signal.

In this embodiment, the configuration information related to the reference signal includes at least one of the following:
time domain resource information;
frequency domain resource information;
transmitting power information;
a modulation scheme;
a coding scheme;
a mapping mode;
resource density; and
a signaling format.

In some embodiments, the time domain resource information is time domain resource information, for example, a time domain location or a time domain length (size), of a measurement resource, and the frequency domain resource information is frequency domain resource information of the measurement resource.

In an embodiment, the frequency domain resource information includes at least one of the following: a frequency domain location (including at least one of a frequency band, a center frequency, a serving cell, and a BWP) and a frequency domain length (size).

In some embodiments, at least one of the transmitting power information (for example, a transmitting power size), the modulation scheme, the coding scheme, the mapping mode, the resource density, and the signaling format (for example, a long or short signaling format) may be pre-agreed-upon, or may be configured by the network-side device.

In some embodiments, the configuration information related to the first backscatter signal includes at least one of the following:
a backscatter signal type;
time domain resource information;
frequency domain resource information;
a modulation scheme;
a coding scheme;
a carrier frequency; and
a reflection coefficient.

In some embodiments, the configuration information related to the first backscatter signal may be preconfigured or agreed upon in a protocol, or may be determined based on an association relationship with the reference signal.

In some embodiments, the backscatter signal type is a type of the first backscatter signal, and may be a specific sequence (for example, 1010101010 or 111111111) or specific information (for example, an RN16, an EPC, or a backscatter signal gain or loss indication). The modulation scheme may be DSB-ASK, SSB-ASK, or PR-ASK. The coding scheme may be Manchester coding, Miller coding, or FM0 coding. In addition, the carrier frequency and/or the reflection coefficient are preconfigured or agreed upon in a protocol for a reader and a tag.

In some embodiments, the time domain resource information is time domain resource information, for example, a time domain location or a time domain length (size), of a backscatter signal, and the frequency domain resource information is frequency domain resource information of the backscatter signal.

In an embodiment, the frequency domain resource information includes at least one of the following: a frequency domain location (including at least one of a frequency band, a center frequency, a serving cell, and a BWP) and a frequency domain length (size).

In some embodiments, the measurement metric includes at least one of the following:
received power of a first backscatter signal;
received quality of a first backscatter signal;
a RSSI;
a SINR;
CLI; and
a CQI.

Herein, each measurement metric may also be referred to as a measurement quantity or a measurement item.

In some embodiments, the received power of the first backscatter signal is the received power of a first backscatter signal that is within first bandwidth and that is centered on a first frequency, where, for example, the first frequency is a carrier frequency;
the RSSI is the received power of a signal that is within second bandwidth and that is centered on a second frequency, where, for example, the second frequency is a carrier frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, and a preset precoding matrix indicator.

It should be noted that the RSSI is power of signals received within entire bandwidth of the second bandwidth by using the second frequency as a center.

In some embodiments, the first frequency and the second frequency may be a backscatter frequency of a tag that is pre-agreed-upon or configured by the network-side device, and the first frequency and the second frequency may be the same or different.

In some embodiments, the first bandwidth and the second bandwidth may also be pre-agreed-upon or configured by the network-side device, and the first bandwidth and the second bandwidth may be the same or different.

In some embodiments, the obtained signal power may be total power or average power of signals.

In some embodiments, the useful signal may be the first backscatter signal, and received power of the useful signal is the received power of the first backscatter signal. The interference power is obtained through interference measurement that is predefined or configured by the network-side device.

In some embodiments, the CLI may be determined by measuring a carrier wave or a control command signal, and is applicable to a scenario with a relay. Interference in the SINR may include the CLI.

In some embodiments, the preset antenna, the preset rank indicator RI, and the preset precoding matrix indicator PMI based on which the CQI is obtained may be predefined, or may be indicated by the network-side device. In a process of obtaining the CQI, for example, a calculated RI, instead of the preset RI, may be used; and a calculated PMI, instead of the preset PMI, may be used.

Further, that the received quality of the first backscatter signal is obtained based on the received power of the first backscatter signal and the RSSI may mean that the received quality of the first backscatter signal is obtained by dividing the received power of the first backscatter signal by the RSSI.

Further, that the SINR is obtained based on received power, interference power, and noise power of a useful signal may mean that the SINR is calculated based on the received power of the first backscatter signal, the interference power, and the noise power. For example, SINR=S/(I+N), where S represents the received power of the first backscatter signal, I represents the interference power, and N represents the noise power. In some embodiments, interference in the SINR may include the CLI.

In addition, for example, in this embodiment, step 702 includes:

The second device sends the reference signal on the measurement resource.

To be specific, after obtaining the measurement configuration information, the second device can send the reference signal on a measurement resource indicated by the measurement configuration information. The reference signal triggers the first backscatter signal. To be specific, if a backscatter communication device receives the reference signal, the first backscatter signal is triggered.

In this embodiment, the method further includes the following step:

The second device receives a measurement result obtained by the channel measurement.

In this case, the second device is a network-side device. After the first device (for example, a terminal) performs channel measurement on the backscatter communication channel based on the measurement configuration information to obtain the measurement result, the network-side device can receive the measurement result sent by the terminal for subsequent processing, for example, adjusting a transmission parameter of the backscatter communication channel.

In some embodiments, the first device (for example, a terminal) reports the measurement result obtained by the channel measurement on a reporting resource indicated by reporting configuration information. Therefore, for example, that the second device receives a measurement result obtained by the channel measurement includes:

The second device receives the measurement result on a corresponding reporting resource based on the reporting configuration information.

In some embodiments, the measurement result is a result of the foregoing measurement metric or measurement item.

In some embodiments, the reporting configuration information is preconfigured information.

In addition, in this embodiment, after the second device receives the measurement result obtained by the channel measurement, the method further includes the following steps:

The second device determines transmission strategy adjustment information based on the measurement result; and
the second device performs at least one of the following:
adjusting a transmission parameter of backscatter communication based on the transmission strategy adjustment information; and
sending the transmission strategy adjustment information to the first device.

Herein, the transmission strategy adjustment information represents an expectation for a transmission parameter of backscatter communication, namely, an adjustment objective. The transmission parameter of backscatter communication is adjusted based on the transmission strategy adjustment information to achieve better backscatter communication.

After receiving the measurement result obtained by the channel measurement, the second device (for example, a network-side device) can determine the transmission strategy adjustment information based on the measurement result, and further adjust the transmission parameter of backscatter communication based on the transmission strategy adjustment information. For example, the second device may send the transmission strategy adjustment information to the first device (for example, a terminal), and the terminal adjusts a transmission parameter of backscatter communication based on the transmission strategy adjustment information. The network-side device may directly adjust the transmission parameter of backscatter communication based on the measurement result.

Herein, the periodicity type is a periodicity type of the reporting resource, and may be a periodic, semi-persistent, or aperiodic type. To be specific, the reporting may be periodic, semi-persistent, or aperiodic reporting. The periodicity length is also a periodicity length of the reporting resource. For example, the periodicity length is 10 ms, 20 ms, or 40 ms. Reporting resource information includes time domain resource information and/or frequency domain resource information of the reporting resource. In some embodiments, the time domain resource information includes at least one of the following: a time domain location and a time domain length (size); and the frequency domain resource information includes at least one of the following: (including at least one of a frequency band, a center frequency, a serving cell, and a BWP) and a frequency domain length (size).

It should be noted that the method in this embodiment of this application is performed by the second device and is implemented in conjunction with the measurement processing method performed by the first device, and the implementation of the method embodiment performed by the first device is applicable to this method, with the same technical effect achieved.

The measurement processing method provided in the embodiments of this application may be performed by a measurement processing apparatus. In the embodiments of this application, a measurement processing apparatus provided in the embodiments of this application is described by using an example in which the measurement processing apparatus performs the measurement processing method.

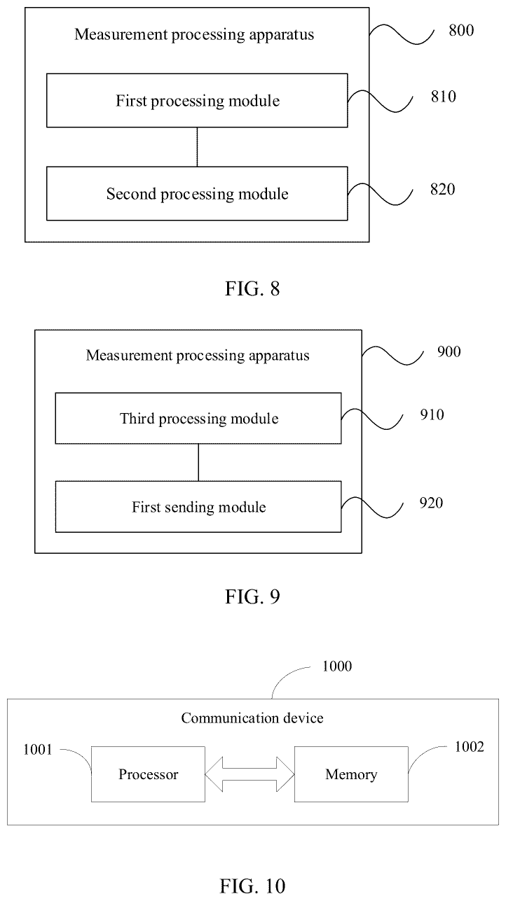

As shown in FIG. 8, a measurement processing apparatus 800 according to an embodiment of this application includes:
a first processing module 810, configured to obtain measurement configuration information; and
a second processing module 820, configured to perform channel measurement on a backscatter communication channel based on the measurement configuration information, where
the backscatter communication channel includes at least one of the following:
a transmission channel for a backscatter signal; and
a transmission channel for a reference signal, where the reference signal is used to trigger a first backscatter signal, and the first backscatter signal is used for channel measurement.

In some embodiments, the measurement configuration information includes at least one of the following:
a measurement metric;
a measurement resource;
a periodicity type;
a periodicity length;
configuration information related to the reference signal; and
configuration information related to the first backscatter signal.

In some embodiments, the apparatus further includes:
a second sending module, configured to send the reference signal based on the measurement configuration information.

In some embodiments, the second processing module is further configured to:
perform channel measurement based on the measurement configuration information by receiving the first backscatter signal.

In some embodiments, the apparatus further includes:
a reporting module, configured to transmit, on a corresponding reporting resource based on reporting configuration information, a measurement result obtained by the channel measurement, where the reporting configuration information is preconfigured information.

In some embodiments, the apparatus further includes:
an obtaining module, configured to obtain transmission strategy adjustment information, where the transmission strategy adjustment information is determined based on the measurement result obtained by the channel measurement; and
a fourth processing module, configured to perform at least one of the following:
adjusting a transmission parameter of backscatter communication based on the transmission strategy adjustment information; and
sending the transmission strategy adjustment information to a second device.

In some embodiments, the periodicity type includes at least one of the following:
periodic;
semi-persistent; and
aperiodic.

In some embodiments, the reference signal includes at least one of the following:
a carrier wave;
a control command; and
a preamble.

In some embodiments, the configuration information related to the reference signal includes at least one of the following:
time domain resource information;
frequency domain resource information;
transmitting power information;
a modulation scheme;
a coding scheme;
a mapping mode;
resource density; and
a signaling format.

In some embodiments, the configuration information related to the first backscatter signal includes at least one of the following:
a backscatter signal type;
time domain resource information;
frequency domain resource information;
a modulation scheme;
a coding scheme;
a carrier frequency; and
a reflection coefficient.

In some embodiments, the measurement metric includes at least one of the following: received power of a first backscatter signal;
received quality of a first backscatter signal;
a received signal strength indicator RSSI;
a signal to interference plus noise ratio SINR;
cross-link interference CLI; and
a channel quality indicator CQI.

In some embodiments, the received power of the first backscatter signal is the received power of a first backscatter signal that is within first bandwidth and that is centered on a first frequency;
the RSSI is the received power of a signal that is within second bandwidth and that is centered on a second frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, and a preset precoding matrix indicator.

In some embodiments, the reporting configuration information includes at least one of the following:
a periodicity type;
a periodicity length; and
reporting resource information.

In some embodiments, a frequency at which the first device performs the channel measurement is greater than or equal to a frequency at which a measurement result is reported based on the channel measurement.

For the backscatter communication channel, the apparatus obtains the measurement configuration information and can perform channel measurement on the backscatter communication channel based on the measurement configuration information to determine channel quality of the backscatter communication channel. This avoids poor communication reliability and other problems caused by uncertainty of channel quality.

The apparatus in this embodiment of this application may be an electronic device, for example, an electronic device with an operating system; or may be a component in an electronic device, for example, an integrated circuit or a chip. The electronic device may be a terminal or another device other than the terminal. For example, the terminal may include but is not limited to the aforementioned types of the terminal 11, and the another device may be a server, a network attached storage (NAS), or the like. This is not specifically limited in this embodiment of this application.

The apparatus provided in this embodiment of this application is capable of implementing the processes implemented in the method embodiments of FIG. 2 to FIG. 6, with the same technical effect achieved. To avoid repetition, details are not described herein again.

As shown in FIG. 9, a measurement processing apparatus 900 according to an embodiment of this application includes:
a third processing module 910, configured to obtain measurement configuration information, where the measurement configuration information is used for channel measurement on a backscatter communication channel; and
a first sending module 920, configured to send a reference signal based on the measurement configuration information, where
the backscatter communication channel includes at least one of the following:
a transmission channel for a backscatter signal; and
a transmission channel for the reference signal, where the reference signal is used to trigger a first backscatter signal, and the first backscatter signal is used for channel measurement.

In some embodiments, the measurement configuration information includes at least one of the following:
a measurement metric;
a measurement resource;
a periodicity type;
a periodicity length;
configuration information related to the reference signal; and
configuration information related to the first backscatter signal.

In some embodiments, the first sending module is further configured to:
send the reference signal on the measurement resource.

In some embodiments, the apparatus further includes:
a receiving module, configured to receive a measurement result obtained by the channel measurement.

In some embodiments, the receiving module is further configured to:
receive the measurement result on a corresponding reporting resource based on reporting configuration information.

In some embodiments, the apparatus further includes:
a determining module, configured to determine transmission strategy adjustment information based on the measurement result; and
a fifth processing module, configured to perform at least one of the following:
adjusting a transmission parameter of backscatter communication based on the transmission strategy adjustment information; and
sending the transmission strategy adjustment information to a first device.

In some embodiments, the periodicity type includes at least one of the following:
periodic;
semi-persistent; and
aperiodic.

In some embodiments, the reference signal includes at least one of the following:
a carrier wave;
a control command; and
a preamble.

In some embodiments, the configuration information related to the reference signal includes at least one of the following:
time domain resource information;
frequency domain resource information;
transmitting power information;
a modulation scheme;
a coding scheme;
a mapping mode;
resource density; and
a signaling format.

In some embodiments, the configuration information related to the first backscatter signal includes at least one of the following:
a backscatter signal type;
time domain resource information;
frequency domain resource information;
a modulation scheme;
a coding scheme;
a carrier frequency; and
a reflection coefficient.

In some embodiments, the measurement metric includes at least one of the following:
received power of a first backscatter signal;
received quality of a first backscatter signal;
a received signal strength indicator RSSI;
a signal to interference plus noise ratio SINR;
cross-link interference CLI; and
a channel quality indicator CQI.

In some embodiments, the received power of the first backscatter signal is the received power of a first backscatter signal that is within first bandwidth and that is centered on a first frequency;
the RSSI is the received power of a signal that is within second bandwidth and that is centered on a second frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, and a preset precoding matrix indicator.

In some embodiments, the reporting configuration information includes at least one of the following:
a periodicity type;
a periodicity length; and
reporting resource information.

In some embodiments, a frequency at which the first device performs the channel measurement is greater than or equal to a frequency at which a measurement result is reported based on the channel measurement.

The apparatus obtains the measurement configuration information and can send the reference signal based on the measurement configuration information to trigger the first backscatter signal. In this way, after obtaining the measurement configuration information, the first device performs channel measurement on the backscatter communication channel based on the measurement configuration information by using the first backscatter signal, to determine channel quality of the backscatter communication channel. This avoids poor communication reliability and other problems caused by uncertainty of channel quality.

The apparatus in this embodiment of this application may be an electronic device, for example, an electronic device with an operating system; or may be a component in an electronic device, for example, an integrated circuit or a chip. The electronic device may be a terminal or another device other than the terminal. For example, the terminal may include but is not limited to the aforementioned types of the terminal 11, and the another device may be a server, a NAS, or the like. This is not specifically limited in this embodiment of this application.

The apparatus provided in this embodiment of this application is capable of implementing the processes implemented in the method embodiment of FIG. 7, with the same technical effect achieved. To avoid repetition, details are not described herein again.

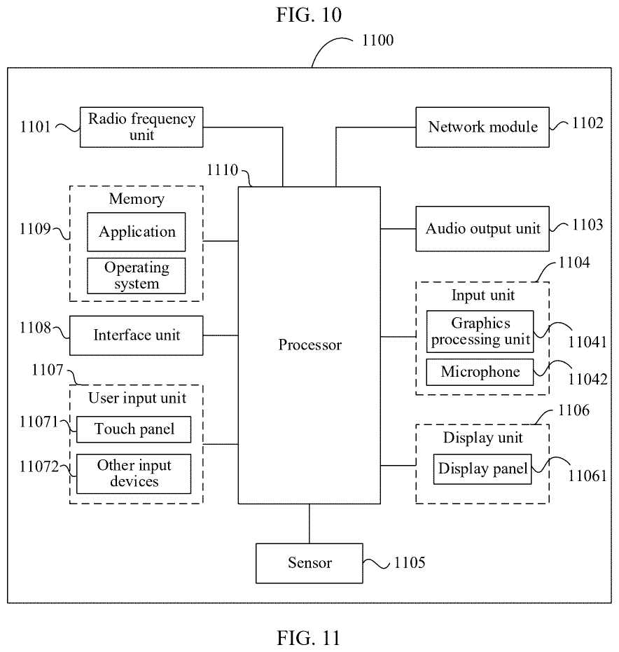

In some embodiments, as shown in FIG. 10, an embodiment of this application further provides a communication device 1000, including a processor 1001 and a memory 1002. The memory 1002 stores a program or instructions capable of running on the processor 1001. For example, in a case that the communication device 1000 is a first device, when the program or instructions are executed by the processor 1001, the steps of the measurement processing method embodiment performed by the first device are implemented, with the same technical effect achieved. In a case that the communication device 1000 is a second device, when the program or instructions are executed by the processor 1001, the steps of the measurement processing method embodiment performed by the second device are implemented, with the same technical effect achieved. To avoid repetition, details are not described herein again.

An embodiment of this application further provides a communication device, including a processor and a communication interface. The processor is configured to obtain measurement configuration information, and perform channel measurement on a backscatter communication channel based on the measurement configuration information, where
the backscatter communication channel includes at least one of the following:
a transmission channel for a backscatter signal; and
a transmission channel for a reference signal, where the reference signal is used to trigger a first backscatter signal, and the first backscatter signal is used for channel measurement.

The communication device embodiment corresponds to the method embodiment on the first device side, and all implementation processes and implementations of the method embodiment are applicable to the communication device embodiment, with the same technical effect achieved. For example, FIG. 11 is a schematic diagram of a hardware structure of a terminal that serves as the communication device and that is configured to implement the embodiments of this application.

The terminal 1100 includes but is not limited to at least some of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

Persons skilled in the art can understand that the terminal 1100 may further include a power supply (for example, a battery) that supplies power to each component. The power supply may be logically connected to the processor 1110 through a power management system, so that functions such as charging management, discharging management, and power consumption management are implemented through the power management system. The terminal structure shown in FIG. 11 does not constitute a limitation on the terminal. The terminal may include more or fewer components than those shown in the figure, or some components may be combined, or different component arrangements may be used. Details are not described herein again.

It should be understood that, in this embodiment of this application, the input unit 1104 may include a graphics processing unit (GPU) 11041 and a microphone 11042. The GPU 11041 processes image data of a static picture or a video that is obtained by an image capture apparatus (for example, a camera) in a video capture mode or an image capture mode. The display unit 1106 may include a display panel 11061. The display panel 11061 may be configured in a form of a liquid crystal display, an organic light-emitting diode, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function button (such as a volume control button or an on/off button), a trackball, a mouse, and a joystick. Details are not described herein.

In this embodiment of this application, after receiving downlink data from a network-side device, the radio frequency unit 1101 may transmit the downlink data to the processor 1110 for processing. In addition, the radio frequency unit 1101 may send uplink data to the network-side device. Usually, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may mainly include a first storage region for storing a program or instructions and a second storage region for storing data. The first storage region may store an operating system, an application or instructions required by at least one function (for example, an audio play function or an image play function), and the like. In addition, the memory 1109 may include a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), or a Direct Rambus RAM (DRRAM). The memory 1109 in this embodiment of this application includes but is not limited to these and any other suitable types of memories.

The processor 1110 may include one or more processing units. In some embodiments, the processor 1110 integrates an application processor and a modem processor. The application processor mainly processes operations related to an operating system, a user interface, an application, and the like. The modem processor mainly processes wireless communication signals, for example, is a baseband processor. It can be understood, for example, that the modem processor may not be integrated in the processor 1110.

The processor 1110 is configured to: obtain measurement configuration information; and
perform channel measurement on a backscatter communication channel based on the measurement configuration information, where
the backscatter communication channel includes at least one of the following:
a transmission channel for a backscatter signal; and
a transmission channel for a reference signal, where the reference signal is used to trigger a first backscatter signal, and the first backscatter signal is used for channel measurement.

For the backscatter communication channel, the terminal obtains the measurement configuration information and can perform channel measurement on the backscatter communication channel based on the measurement configuration information to determine channel quality of the backscatter communication channel. This avoids poor communication reliability and other problems caused by uncertainty of channel quality.

In some embodiments, the measurement configuration information includes at least one of the following:
a measurement metric;
a measurement resource;
a periodicity type;
a periodicity length;
configuration information related to the reference signal; and
configuration information related to the first backscatter signal.

In some embodiments, the radio frequency unit 1101 is configured to:
send the reference signal based on the measurement configuration information.

In some embodiments, the processor 1110 is further configured to:
perform channel measurement based on the measurement configuration information by receiving the first backscatter signal.

In some embodiments, the radio frequency unit 1101 is configured to:
transmit, on a corresponding reporting resource based on reporting configuration information, a measurement result obtained by the channel measurement, where the reporting configuration information is preconfigured information.

In some embodiments, the processor 1110 is further configured to:
obtain transmission strategy adjustment information, where the transmission strategy adjustment information is determined based on the measurement result obtained by the channel measurement; and
perform at least one of the following:
adjusting a transmission parameter of backscatter communication based on the transmission strategy adjustment information; and
sending the transmission strategy adjustment information to a second device.

In some embodiments, the periodicity type includes at least one of the following:
periodic;
semi-persistent; and
aperiodic.

In some embodiments, the reference signal includes at least one of the following:
a carrier wave;
a control command; and
a preamble.

In some embodiments, the configuration information related to the reference signal includes at least one of the following:
time domain resource information;
frequency domain resource information;
transmitting power information;
a modulation scheme;
a coding scheme;
a mapping mode;
resource density; and
a signaling format.

In some embodiments, the configuration information related to the first backscatter signal includes at least one of the following:
a backscatter signal type;
time domain resource information;
frequency domain resource information;
a modulation scheme;
a coding scheme;
a carrier frequency; and
a reflection coefficient.

In some embodiments, the measurement metric includes at least one of the following:
received power of a first backscatter signal;
received quality of a first backscatter signal;
a received signal strength indicator RSSI;
a signal to interference plus noise ratio SINR;
cross-link interference CLI; and
a channel quality indicator CQI.

In some embodiments, the received power of a first backscatter signal is the received power of the first backscatter signal that is within first bandwidth and that is centered on a first frequency;
the RSSI is the received power of a signal that is within second bandwidth and that is centered on a second frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, and a preset precoding matrix indicator.

In some embodiments, the reporting configuration information includes at least one of the following:
a periodicity type;
a periodicity length; and
reporting resource information.

In some embodiments, a frequency for the channel measurement is greater than or equal to a frequency at which a measurement result is reported based on the channel measurement.

It should be noted that, in this embodiment, the terminal may perform the measurement processing method performed by the second device. Details are not described herein again.

An embodiment of this application further provides a communication device, including a processor and a communication interface. The processor is configured to obtain measurement configuration information, where the measurement configuration information is used for channel measurement on a backscatter communication channel. The communication interface is configured to send a reference signal based on the measurement configuration information.

The backscatter communication channel includes at least one of the following:
a transmission channel for a backscatter signal; and
a transmission channel for the reference signal, where the reference signal is used to trigger a first backscatter signal, and the first backscatter signal is used for channel measurement.

The communication device embodiment corresponds to the method embodiment on the second device side, and all implementation processes and implementations of the method embodiment are applicable to the communication device embodiment, with the same technical effect achieved.

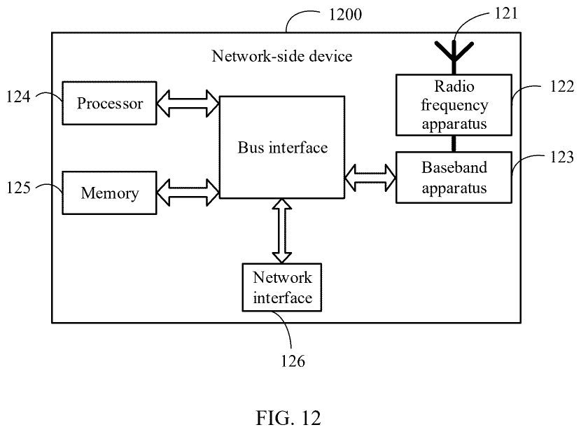

For example, an embodiment of this application further provides a network-side device serving as the communication device. As shown in FIG. 12, the network-side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes to-be-sent information, and sends the information to the radio frequency apparatus 122; and the radio frequency apparatus 122 processes the received information and then sends the information through the antenna 121.

The method performed by the network-side device in the foregoing embodiments may be implemented in the baseband apparatus 123, and the baseband apparatus 123 includes a baseband processor.

The baseband apparatus 123 may include, for example, at least one baseband board, where a plurality of chips are disposed on the baseband board. As shown in FIG. 12, one of the chips is, for example, the baseband processor, which is connected to the memory 125 through a bus interface, to invoke a program in the memory 125 to perform the operations of the network device shown in the foregoing method embodiments.

The network-side device may further include a network interface 126. The interface is, for example, a common public radio interface (CPRI).

For example, the network-side device 1200 in this embodiment of this application further includes instructions or a program stored in the memory 125 and capable of running on the processor 124, and the processor 124 invokes the instructions or program in the memory 125 to perform the method performed by the modules shown in FIG. 9, with the same technical effect achieved. To avoid repetition, details are not described herein again.

It should be noted that, in this embodiment, the network-side device may perform the measurement processing method performed by the first device. Details are not described herein again.

An embodiment of this application further provides a readable storage medium. The readable storage medium stores a program or instructions. When the program or instructions are executed by a processor, the measurement processing method performed by the first device is implemented, or the processes in the measurement processing method embodiment performed by the second device are implemented, with the same technical effect achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions, to implement the measurement processing method performed by the first device, or implement the processes in the measurement processing method embodiment performed by the second device, with the same technical effect achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program or program product. The computer program or program product is stored in a storage medium. The computer program or program product is executed by at least one processor to implement the measurement processing method performed by the first device, or implement the processes in the measurement processing method embodiment performed by the second device, with the same technical effect achieved. To avoid repetition, details are not described herein again.

An embodiment of this application further provides a measurement processing system, including a first device and/or a second device. The first device may be configured to perform the steps of the measurement processing method performed by the first device. The second device may be configured to perform the steps of the measurement processing method performed by the second device.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the shown or described order, but may also include performing functions in a substantially simultaneous manner or in a reverse order depending on the functions involved. For example, the described method may be performed in an order different from that described, and steps may be added, omitted, or combined. In addition, features described with reference to some examples may be combined in other examples.

According to the foregoing descriptions of the implementations, persons skilled in the art can clearly understand that the methods in the foregoing embodiments may be implemented by using software in combination with a necessary common hardware platform, or may be implemented by using hardware. However, in most cases, the former is an example implementation. Based on such an understanding, the technical solutions of this application essentially or the part contributing to the related art may be implemented in a form of a computer software product. The computer software product may be stored in a storage medium (for example, a ROM/RAM, a magnetic disk, or a compact disc), and includes several instructions for instructing a terminal (which may be a mobile phone, a computer, a server, an air conditioner, a network device, or the like) to perform the methods in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, persons of ordinary skill in the art may further make many modifications without departing from the purposes of this application and the protection scope of the claims, and all the modifications shall fall within the protection scope of this application.

What is claimed is:

1. A measurement processing method, comprising:
obtaining, by a first device, measurement configuration information; and
performing, by the first device, channel measurement on a backscatter communication channel based on the measurement configuration information, wherein
the backscatter communication channel comprises at least one of the following:
a transmission channel for a backscatter signal; or
a transmission channel for a reference signal, wherein the reference signal is used to trigger a first backscatter signal, and the first backscatter signal is used for the channel measurement.

2. The method according to claim 1, wherein the measurement configuration information comprises at least one of the following:
a measurement metric;
a measurement resource;
a periodicity type;
a periodicity length;
configuration information related to the reference signal; or
configuration information related to the first backscatter signal.

3. The method according to claim 2, wherein before the performing, by the first device, the channel measurement on the backscatter communication channel based on the measurement configuration information, the method further comprises:
sending, by the first device, the reference signal based on the measurement configuration information.

4. The method according to claim 1, wherein the performing, by the first device, the channel measurement on the backscatter communication channel based on the measurement configuration information comprises:
performing, by the first device, the channel measurement based on the measurement configuration information by receiving the first backscatter signal.

5. The method according to claim 4, wherein after the performing, by the first device, the channel measurement based on the measurement configuration information by receiving the first backscatter signal, the method further comprises:
transmitting, by the first device, a measurement result obtained by the channel measurement on a corresponding reporting resource based on reporting configuration information, wherein the reporting configuration information is preconfigured information.

6. The method according to claim 1, wherein after the performing, by the first device, the channel measurement on the backscatter communication channel based on the measurement configuration information, the method further comprises:
obtaining, by the first device, transmission strategy adjustment information, wherein the transmission strategy adjustment information is determined based on the measurement result obtained by the channel measurement; and
performing, by the first device, at least one of the following:
adjusting a transmission parameter of backscatter communication based on the transmission strategy adjustment information; or
sending the transmission strategy adjustment information to a second device.

7. The method according to claim 2, wherein the periodicity type comprises at least one of the following:
periodic;
semi-persistent; or
aperiodic, or
the reference signal comprises at least one of the following:
a carrier wave;
a control command; or
a preamble.

8. The method according to claim 2, wherein the configuration information related to the reference signal comprises at least one of the following:
time domain resource information;
frequency domain resource information;
transmitting power information;
a modulation scheme;
a coding scheme;
a mapping mode;
resource density; or
a signaling format.

9. The method according to claim 2, wherein the configuration information related to the first backscatter signal comprises at least one of the following:
a backscatter signal type;
time domain resource information;
frequency domain resource information;
a modulation scheme;
a coding scheme;
a carrier frequency; or
a reflection coefficient.

10. The method according to claim 2, wherein the measurement metric comprises at least one of the following:
received power of a first backscatter signal;
received quality of a first backscatter signal;
a received signal strength indicator (RSSI);
a signal to interference plus noise ratio (SINR);
cross-link interference (CLI); or
a channel quality indicator (CQI).

11. The method according to claim 10, wherein the received power of the first backscatter signal is the received power of a first backscatter signal that is within first bandwidth and that is centered on a first frequency;
the RSSI is the received power of a signal that is within second bandwidth and that is centered on a second frequency;
the received quality of the first backscatter signal is obtained based on the received power of the first backscatter signal and the RSSI;
the SINR is obtained based on received power, interference power, and noise power of a useful signal; and
the CQI is obtained based on at least one of the following:
preset antenna reception, a preset rank indicator, or a preset precoding matrix indicator.

12. The method according to claim 5, wherein the reporting configuration information comprises at least one of the following:
a periodicity type;
a periodicity length; or
reporting resource information.

13. The method according to claim 1, wherein a frequency at which the first device performs the channel measurement is greater than or equal to a frequency at which a measurement result is reported based on the channel measurement.

14. A measurement processing method, comprising:
obtaining, by a second device, measurement configuration information, wherein the measurement configuration information is used for channel measurement on a backscatter communication channel; and
sending, by the second device, a reference signal based on the measurement configuration information, wherein
the backscatter communication channel comprises at least one of the following:
a transmission channel for a backscatter signal; or
a transmission channel for the reference signal, wherein the reference signal is used to trigger a first backscatter signal, and the first backscatter signal is used for the channel measurement.

15. The method according to claim 14, wherein the measurement configuration information comprises at least one of the following:
a measurement metric;
a measurement resource;
a periodicity type;
a periodicity length;
configuration information related to the reference signal; or
configuration information related to the first backscatter signal.

16. The method according to claim 15, wherein the sending, by the second device, the reference signal based on the measurement configuration information comprises:
sending, by the second device, the reference signal on the measurement resource.

17. The method according to claim 14, further comprising:
receiving, by the second device, a measurement result obtained by the channel measurement.

18. The method according to claim 17, wherein the receiving, by the second device, the measurement result obtained by the channel measurement comprises:
receiving, by the second device, the measurement result on a corresponding reporting resource based on reporting configuration information.

19. The method according to claim 17, wherein after the receiving, by the second device, the measurement result obtained by the channel measurement, the method further comprises:
determining, by the second device, transmission strategy adjustment information based on the measurement result; and
performing, by the second device, at least one of the following:
adjusting a transmission parameter of backscatter communication based on the transmission strategy adjustment information; or
sending the transmission strategy adjustment information to a first device.

20. A communication device, comprising a processor and a memory storing instructions wherein the instructions, when executed by the processor, cause the processor to perform operations comprising:
obtaining measurement configuration information; and
performing channel measurement on a backscatter communication channel based on the measurement configuration information, wherein
the backscatter communication channel comprises at least one of the following:
a transmission channel for a backscatter signal; or
a transmission channel for a reference signal, wherein the reference signal is used to trigger a first backscatter signal, and the first backscatter signal is used for the channel measurement.
